(19) United States
(12) Patent Application Publication
(10) Pub. No.: US 2017/0201870 A1
(43) Pub. Date: Jul. 13, 2017

(54) Method and Device for Sending Message by Background Program

(71) Applicant: Beijing Qihoo Technology Company Limited, Beijing (CN)

(72) Inventor: Jiyun Liu, Beijing (CN)

(73) Assignee: Beijing Qihoo Technology Company Limited, Beijing (CN)

(21) Appl. No.: 15/318,535

(22) PCT Filed: Jun. 4, 2015
(86) PCT No.: PCT/CN2015/080764

§ 371 Date: Mar. 27, 2017

(30) Foreign Application Priority Data
Jun. 13, 2014 (CN) 201410265900.9

(51) Int. Cl. H04W 4/12; H04L 29/06; H04L 29/12

(52) U.S. Cl. CPC H04W 4/12; H04L 61/1594; H04L 63/0853

(57) ABSTRACT

The present invention discloses a method and device for message sending by a background program. The method for message sending by a background program comprises: acquiring a connection channel for message sending by a background program; according to a scenario of message sending by the background program, constructing a message to be sent; acquiring an interface for message sending by the background program; uploading the constructed message to the interface for message sending by the background program via the connection channel for message sending by the background program; and sending, by the background program, the message via the interface for message sending by the background program. The embodiment realizes automatic message sending by a background program, without the need for inputting a phone number or message content by a user, and the sending process does not affect the normal operation of the system.

### TECHNICAL FIELD

The present invention relates to technology for sending message, and specifically to a method and device for sending message by a background program.

### BACKGROUND

Current technology of message sending are mostly limited to foreground manual sending, and the message content to be sent and the phone number are manually entered. However, in some specific cases, it is desirable to achieve automatic message sending by a mobile phone background program. For example, in respect of antitheft of mobile phones, when a user changes a SIM card, the mobile phone needs to send, via the background program, a message to notify specific contacts that the user has changed for this mobile phone and this mobile phone might have be stolen. Additionally, after the mobile phone is stolen, the mobile phone background program executes some operations according to the user's request and automatically sends a message to notify the user of an execution result of the operations. Additionally the mobile phone background program, according to the user's needs, sends a message regularly to query about situations such as usage of traffic flow of the user's mobile phone. All of those need to be realized by automatic message sending by a mobile phone background program.

### SUMMARY

In view of the above problems, the present invention provides a method and device for message sending by a background program, which can solve the above problems or at least partially solve the above problems.

According to an aspect of the present invention, there is provided a method for sending message by a background program, comprising:

Acquiring a connection channel for message sending by the background program;
constructing a message to be sent, according to a scenario of message sending by the background program;
acquiring an interface for message sending by the background program; and
uploading the constructed message to the interface via the connection channel and sending, by the background program, the message via the interface

According to another aspect of the present invention, there is provided a device for sending message by a background program, comprising:

A first acquiring unit adapted to acquire a connection channel for message sending by a background program;
a message constructing unit adapted to, construct a message to be sent, according to a scenario of message sending by the background program;
a second acquiring unit adapted to acquire an interface for message sending by the background program; and
a sending unit adapted to upload the constructed message to the interface via the connection channel, and send, by the background program, the message via the interface.

The present embodiment realizes automatic message sending by the background program without the need for inputting a phone number or message content by a user, and the sending process does not affect the normal operation of the system, thereby achieving a function that cannot be achieved by foreground message sending.

According to a further aspect of the present invention, there is provided a computer program comprising a computer readable code, wherein when the computer readable code is run on a terminal, it causes the terminal to execute the above-mentioned method.

According to a further aspect of the present invention, there is provided a computer readable medium, in which the above-mentioned computer program stored thereon.

As can be seen from the above embodiments, the advantageous effects of the present invention as compared with the prior art are as follows: the present invention realizes automatic message sending by the background program without the need for a inputting a phone number or message content by a user, and the sending process does not affect the normal operation of the system, thereby achieving a function that cannot be achieved by foreground message sending.

Described above is merely an overview of a technical solution of the present invention. In order to more apparently understand the technical means of the present invention to implement in accordance with the contents of specification, and to more readily understand above and other objectives, features and advantages of the present invention, particular embodiments of the present invention are provided hereinafter.

### BRIEF DESCRIPTION OF THE DRAWINGS

Various other advantages and merits will become apparent to those skilled in the art by reading the following detailed description of preferred embodiments. The drawings are only intended to illustrate the preferred embodiments and not construed as limiting the present invention. In the drawings, like reference numbers denote like elements. In the drawings:

FIG. 1 illustrates a flow chart of a method for sending message by a background program according to Embodiment 1 of the present invention;

FIG. 2 illustrates a structural diagram of a device for sending message by a background program according to Embodiment 5 of the present invention;

FIG. 3 illustrates a block diagram of a terminal for implementing the method according to the present invention; and

FIG. 4 illustrates a storage unit for maintaining or carrying a program code for implementing the method according to the present invention.

### DETAILED DESCRIPTION OF THE EMBODIMENTS

The following will describe in more detail the exemplary embodiments of the present invention with reference to the accompanying drawings. Although the accompanying drawings display the exemplary embodiments of the present invention, it should be understood that the present invention may be implemented in various forms but not limited by the embodiments set forth herein. Instead, these embodiments are provided to more thoroughly understand the present invention, and completely convey the scope of the present invention to those skilled in the art.

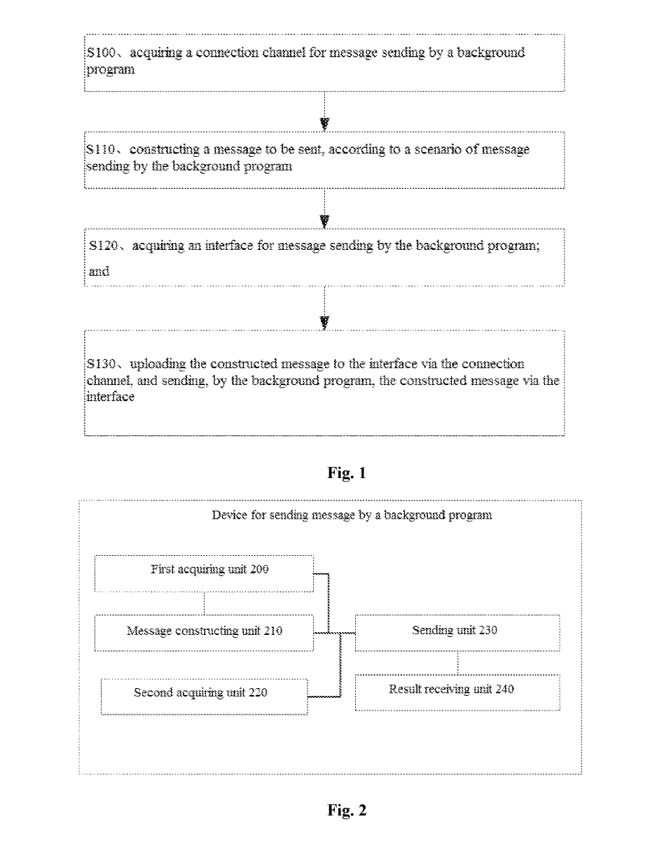

Embodiment 1 illustrates a method for sending message by a background program. The method of the present embodiment is illustrated with reference to FIG. 1.

In FIG. 1, S100: acquiring a connection channel for message sending by the background program.

The message sending by the background program as stated in the present embodiment and the subsequent embodiments refers to a behavior of directly sending a message quietly without invoking a message interface. The background program refers to a program which the user does not contact directly. The background program may be any program, or even an apparatus accomplishing a corresponding function.

The connection channel for message sending by the background program of the present embodiment is a communication channel between a message constructing process and a message sending process.

In that, in the present embodiment a system private interface is invoked as the connection channel for message sending by the background program, and the system private interface is xpc Connection, and the return value of the private interface xpc Connection is conn. The private interface is an interface whose all information such as function, parameters and return value are not open to the public. The execution code of the method of acquiring a connection channel for message sending by the background program according to an embodiment of the present invention is as follows:
Class clientCon=objc_getClass(“CKClientComposeConversation”);
id conn=[clientCon_xpcConnection].

S110: constructing a message to be sent, according to a scenario of message sending by the background program.

In that, the message to be sent of the present embodiment comprises two parts, namely, field and content, wherein the fields and the meanings of the fields are as follows:

(1) “message-type”: represents information type, wherein the information types comprise “SMS” and “iMessage”.

(2) “recipients”: represents a message recipient, is an array and may store the phone numbers (mobile phone numbers, not landline phone numbers) or E-mail addresses of a plurality of contacts. The phone numbers or E-mail addresses of the plurality of contacts comprise: at least one message recipient phone number or E-mail address preset by the user, or at least one message recipient phone number or E-mail address that is selected from mobile phone contacts and that has a maximum number of calls, or at least one message recipient phone number or E-mail address that is selected from mobile phone contacts and whose call duration is the longest, or at least one message recipient phone number or E-mail address selected randomly from all contacts.

In the present embodiment, the method of selecting the message recipient varies for different scenarios of message sending by the background program. For example, in order to prevent a thief from changing the SIM card when he steals the mobile phone, the background program needs to send a message to notify a designated recipient in the scenario in which SIM card has changed for the mobile phone, and the message recipient may be one or more of anti-theft contacts who are already stored in the array and preset by the user; the message recipient may be one or more contacts who are selected from the mobile phone contacts and who have a maximum number of calls, or one or more contacts who are selected from the mobile phone contacts and whose call duration is the longest, or one or more contacts selected randomly from all mobile phone contacts.

In the scenario in which the background program executes a user operation instruction after the mobile phone is stolen and then replies with a message, the recipient of the message sending by the background program is a phone number or E-mail address that sends the operation instruction.

In the scenario in which the background program automatically subscribes to services, the message recipient is the mobile phone or E-mail address for subscribing services that is set by the user.

In the scenario in which the background program automatically replies with a message after a phone call is rejected, the message recipient is a rejected phone number.

It should be noted that the phone number needs to be used as the message recipient for SMS messages, and the phone number or E-mail address may be used as the message recipient for iMessage.

(3) “markup”: represents the message content to be sent.

(4) “subject”: represents a subject of the message to be sent. The subject of the message of the present embodiment corresponds to the content of the message, that is, different subjects correspond to different message content. The message subject may be determined according to the scenario of message sending by the background program. For example, as for the scenario in which the SIM card of the mobile phone is changed, the subject may be set as “mobile phone theft reminder”, and the message content it corresponds to may be “user has changed for this mobile phone and this mobile phone might have be stolen”. As for the scenario in which the background program automatically replies with a message after a phone call is rejected, the subject may be set as “message reply after a phone call rejection”, and the message content it corresponds to may be “busy and inconvenient to answer the phone call”. The above are only specific examples listed by the inventor, and the present embodiment is not limited to those.

(5) “forceSMS”: represents whether to send a message forcedly rather than to send by iMessage.

(6) “guid”: represents an unique identifier of the message which is calculated according to an algorithm.

In that, SMS (Short MessageService) is a storing and forwarding service. That is to say, the message is not directly sent from a sender to a recipient, but always forwarded by a message service center. If the recipient is in a disconnected state, the message will be sent when the recipient is connected again.

In that, iMessage is an instant communication function software which is issued by Apple Inc. and capable of sending words, pictures, videos, contacts and positional information and the like between equipment on which iOS and Mac Operating System are applied, and supports multiple-contact chat. The iMessage is different from an operator's message/multimedia message service, and a user may accomplish communication only by performing data support via WiFi or 3G network. The iMessage can directly push the information to the screen of the other party, regardless of whether the other party is playing a game or is in a screen-locked state.

S120: acquiring an interface for message sending by the background program.

In the present embodiment a system private interface is invoked as the interface for message sending by the background program, and the private interface is xpc_send_message. The private interface xpc_send_message comprises two parameters: one parameter is the connection channel obtained above, and the other parameter is the above constructed message, which is specifically represented in the following form:

xpc_send_message(conn, dic).

S130: uploading the constructed message to the interface for message sending by the background program via the connection channel for message sending by the background program, and sending, by the background program, the message via the interface for message sending by the background program.

In the present embodiment, the message content is sent to the message recipient determined in the above Step S110 via the interface for message sending by the background program.

In the present embodiment, when the background program sends the message, it receives a result indicating whether the message is successfully sent, that is to say, after the background program sends the message to a preset address, it will receive a message indicating whether the message is successfully sent. If the message is not successfully sent, it may attempt to resend. The limitation to the times of the resending may be set. For example, a message sent by each background program is resent three times at most.

The present embodiment may operate in the iOS system.

The present embodiment realizes automatic message sending by the background program without the need for inputting a phone number or message content by a user, and the sending process does not affect the normal operation of the system. Meanwhile, since the background program receives a message indicating whether the message is successfully sent during the sending process, the result of message sending may be obtained. Resending is attempted in the event of sending failure, thereby improving the success rate of message sending by the background program so that the process of the message sending by the background program is controllable.

The method for sending message by a background program according to the present embodiment may be applied to multiple scenarios, for example, the scenario in which SIM card has changed for the mobile phone, the scenario in which the background program executes a user operation instruction after the mobile phone is stolen and then replies with a message, the scenario in which the background program automatically subscribes to services, the scenario in which the background program automatically replies with a message after a phone call is rejected, and the like. It should be understood that the method for message sending by a background program according to the present embodiments of the present invention is not limited to the above scenarios. Specific implementations of the method for message sending by a background program are illustrated exemplarily by the embodiments of the present invention.

Embodiment 2 illustrates that the method for sending message by a background program is applied to the scenario in which SIM card has changed for the mobile phone. After the mobile phone is stolen, the new user may change the SIM card, so the change of the SIM card by the user is regarded as a scenario for the background program to send a message in mobile phone antitheft. The background program sends the message to notify a designated recipient that this mobile phone might have be stolen to thereby prevent contacts stored in the mobile phone from being deceived. Alternatively, the current location of the mobile phone may be determined according to the message sent from the background program so that a further processing step will be taken. The present embodiment specifically comprises:

Firstly, after the change of SIM card for the mobile phone is recognized, the connection channel for message sending by the background program is acquired. The execution code for acquiring the connection channel for message sending by the background program is as follows:

Class clientCon=objc_getClass(“CKClientComposeConversation”);

id conn=[clientCon_xpcConnection];

Then, the message is constructed according to a scenario of message sending by the background program. For example, the determined information is as follows:

(1) Information type “message-type” is: “SMS”;

(2) Message recipients “recipients”: one or more of anti-theft contacts who are preset and stored by the user;

(3) Message content to be sent “markup”: “user has changed for this mobile phone and this mobile phone might have be stolen”;

(4) Subject of the message to be sent “subject”: “mobile phone theft reminder”;

(5) Whether to send a message forcedly “forceSMS”: yes; and

(6) The unique identifier of the message “guid”: a unique identifier that is obtained by calculating randomly, for example as follows:

F9619FF-8B86-D011-B42D-00C04FC964FF;

Then, an interface for message sending by the background program is acquired as xpc_send_message.

Finally, via the connection channel xpcConnection for message sending by the background program, the above constructed message is uploaded to the interface xpc_send_message for message sending by the background program, and the background program sends the message to the selected message recipient through the interface.

A result message indicating whether the message is successfully sent is received. If it is successfully sent, the flow ends.

In the present embodiment, the method for sending message by a background program is applied to the scenario in which SIM card has changed for the mobile phone. After the message recipient receives the antitheft reminder, the message recipient may contact the current mobile phone user to confirm whether the user changes, thereby preventing the new user of the mobile phone from using the mobile phone to send deceptive messages to the contacts already stored in the mobile phone when the mobile phone is stolen. The function of sending message by the background program surpasses the function of the foreground message sending, and effectively prevents the contacts stored in the mobile phone from being deceived.

Embodiment 3 illustrates that the method for sending message by a background program is applied to the scenario in which the background program executes a user operation instruction after the mobile phone is stolen and then replies with a message. After the user's mobile phone is stolen, some data stored by the user in the mobile phone might leak, which is not desired by the mobile phone user. Hence, after the mobile phone is stolen, the user may send a message to the original mobile phone to inform it to delete specific content, for example, delete pictures, videos and contacts stored in the mobile phone. The message may be sent through a preset specific instruction. The mobile phone receiving the message, after recognizing the instruction, intercepts the message and refrains the message from displaying to the user. At this time, the mobile phone receiving the message replies, through the background program, a message to notify the user whether the instruction is successfully executed. The present embodiment specifically comprises:

Firstly, after one instruction (or more or all instructions) has been executed, acquiring the connection channel xpc Connection for message sending by the background program.

In the present embodiment, the already-executed instruction is deleting all the pictures in the mobile phone.

Then, the message is constructed according to the instruction execution result. For example, the determined information is as follows:

(1) Information type “message-type” is: “SMS”;

(2) Message recipients “recipients”: the phone number for sending the instruction;

(3) Message content to be sent “markup”: “all the pictures in the mobile phone have already been deleted successfully”;

(4) Subject of the message to be sent “subject”: “picture deletion result”;

(5) Whether to send a message forcedly “forceSMS”: yes; and

(6) The unique identifier of the message “guid”: a unique identifier that is obtained by calculating randomly, for example as follows:

E5324AA-7A5C-F266-B24Y-11A14FC946EE;

Then, an interface for message sending by the background program is obtained as xpc_send_message.

Finally, via the connection channel for message sending by the background program, the above constructed message is uploaded to the interface xpc_send_message for message sending by the background program, and the background program sends the message to the phone number of sending the instruction through the interface.

A result message indicating whether the message is successfully sent is received. In the event of sending failure, an attempt is made to resend the message.

In the present embodiment, the method for message sending by a background program is applied to the scenario in which a message is replied for mobile phone antitheft, thereby effectively preventing the leakage of the user's information after the mobile phone is stolen or get lost. This operation also cannot be achieved by foreground message sending.

Embodiment 4 illustrates that the method for sending message by a background program is applied to the scenario in which the background program automatically subscribes to services. Take the background program sending a message to query about usage of the user's current mobile phone traffic flow as an example. The user subscribed to a certain amount of traffic flow every month. To avoid exceeding the amount of traffic flow, the user sets in a way that the background program sends a message to query about usage of the user's current mobile phone traffic flow on the 10^{th} day, 20^{th} day and 25^{th} day of every month. The present embodiment specifically comprises:

Firstly, the current date 10^{th} day is recognized and set as the date on which the background program is required to query about usage of the user's current mobile phone traffic flow, and then the connection channel xpc Connection for message sending by the background program is acquired.

In the present embodiment, the query message may be set to be sent at a fixed time of the specified date. For example, the query message is set to be sent at 8:00 am of the specified date.

Then, the message is constructed. For example, the determined information is as follows:

(1) Information type “message-type” is: “SMS”;

(2) Message recipients “recipients”: a set service phone number of an operator for example 10086.

(3) Message content to be sent “markup”: “usage of traffic flow of the mobile phone in this month up to Feb. 10 , 2014”;

(4) Subject of the message to be sent “subject”: “traffic flow query”;

(5) Whether to send a message forcedly “forceSMS”: yes; and

(6) A unique identifier of the message “guid”: a unique identifier that is obtained by calculating randomly, for example as follows:

F2365BB-5B7C-F351-B12C-54A36CB257FF;

Then, an interface for message sending by the background program is acquired as xpc_send_message.

Finally, via the connection channel for message sending by the background program, the above constructed message is uploaded to the interface xpc_send_message for message sending by the background program, and the background program sends the message to 10086 through the interface.

A result message indicating whether the message is successfully sent is received. If it is successfully sent, the flow ends.

In the present embodiment, the method for sending message by a background program is applied to the scenario of querying about usage of the user's current mobile phone traffic flow, implements automatically querying about usage of the user's current mobile phone traffic flow and avoids incurring extra fees as exceeding the subscribed amount of traffic flow. The operation of the background program sending the message for query ensures punctuality of time, avoids exceeding the subscribed amount of traffic flow because the user forget to query, and meanwhile simplifies the user's operation.

Embodiment 5 illustrates a device for sending message by a background program. The device is described in detail in combination with FIG. 2.

The device for sending message by a background program according to the present embodiment may be disposed in a mobile communication equipment using iOS system. The device mainly comprises a first acquiring unit 200, a message constructing unit 210, a second acquiring unit 220 and a sending unit 230, and the device may further comprise a result receiving unit 240. In that, the sending unit 230 is connected to the first acquiring unit 200, the message constructing unit 210, the second acquiring unit 220 and the result receiving unit 240.

In that, the first acquiring unit 200 is mainly adapted to acquire a connection channel for message sending by the background program.

The connection channel for message sending by the background program of the present embodiment is a communication channel between a message constructing process and a message sending process.

In that, the first acquiring unit 200 of the present embodiment invokes a system private interface as the connection channel for message sending by the background program, and the system private interface is xpcConnection, whose return value is conn. The private interface is an interface whose all information such as function, parameters and return value are not open to the public. The execution code of the method for the first acquiring unit 200 to acquire the connection channel for message sending by the background program of the present embodiment is as follows:

Class clientCon=objc_getClass(“CKClientComposeConversation”);

id conn=[clientCon_xpcConnection].

In that, the message constructing unit 210 is mainly adapted to construct a message to be sent according to a scenario of message sending by the background program.

In that, the message to be sent constructed by the message constructing unit 210 of the present embodiment comprises two parts, namely, field and content, wherein the fields and the meanings of the fields are as follows:

(1) “message-type”: represents information type, wherein the information types are “SMS” and “iMessage”.

(2) “recipients”: represents a message recipient, is an array and may store the phone numbers (mobile phone numbers, not landline phone numbers) or E-mail addresses of a plurality of contacts. The information of contacts stored in the array comprises: at least one message recipient phone number or E-mail address preset by the user, or at least one message recipient phone number or E-mail address that is selected from mobile phone contacts and that has a maximum number of calls, or at least one message recipient phone number or E-mail address that is selected from mobile phone contacts and whose call duration is the longest, or at least one message recipient phone number or E-mail address selected randomly from all contacts.

In the present embodiment, the method of selecting the message recipient varies for different scenarios of message sending by the background program. For example, in order to prevent a thief from changing the SIM card when he steals the mobile phone, the background program needs to send a message to notify a designated recipient in the scenario in which SIM card has changed for the mobile phone, and the message recipient may be one or more of anti-theft contacts who are already stored in the array and preset by the user; the message recipient may be one or more contacts who are selected from the mobile phone contacts and who have a maximum number of calls, or one or more contacts who are selected from the mobile phone contacts and whose call duration is the longest, or one or more contacts selected randomly from all mobile phone contacts.

In the scenario in which the background program executes a user operation instruction after the mobile phone is stolen and then replies with a message, the recipient of the message sending by the background program is a phone number or E-mail address that sends the operation instruction.

In the scenario in which the background program automatically subscribes to services, the message recipient is the mobile phone or E-mail address for subscribing services that is set by the user.

In the scenario in which the background program automatically replies with a message after a phone call is rejected, the message recipient is a rejected phone number.

It should be noted that the phone number needs to be used as the message recipient for SMS messages, and the phone number or E-mail address may be used as the message recipient for iMessage.

(3) “markup”: represents the message content to be sent.

(4) “subject”: represents the subject of the message to be sent. The subject of the message of the present embodiment corresponds to the content of the message, that is, different subjects correspond to different message content. The message subject may be determined according to the scenario of message sending by the background program. For example, as for the scenario in which the SIM card of the mobile phone is changed, the subject may be set as “mobile phone theft reminder”, and the message content it corresponds to may be “user has changed for this mobile phone and this mobile phone might have be stolen”. The above is only a specific example listed by the inventor, and the present embodiment is not limited to those.

(5) “forceSMS”: represents whether to send a message forcedly rather than to send by iMessage;

(6) “guid”: represents the unique identifier of the message which is calculated according to an algorithm.

In that, SMS (Short Message Service) is a store and forwarding service. That is to say, the message is not directly sent from a sender to a recipient, but always forwarded by a message service center. If the recipient is in a disconnected state, the message will be sent when the recipient is connected again.

In that, iMessage is an instant communication function software which is issued by Apple Inc. and capable of sending words, pictures, videos, contacts and positional information and the like between equipment on which iOS and Mac Operating System are applied, and supports multiple-contact chat. The iMessage is different from an operator's message/multimedia message service, and a user may accomplish communication only by performing data support via WiFi or 3G network. The iMessage can directly push the information to the screen of the other party, regardless of whether the other party is playing a game or is in a screen-locked state.

In that, the second acquiring unit 220 is mainly adapted to acquire an interface for message sending by the background program.

In the present embodiment, the second acquiring unit 220 invokes a system private interface as the interface for message sending by the background program, and the private interface is xpc_send_message. The private interface xpc_send_message comprises two parameters: one parameter is the connection channel obtained above, and the other parameter is the above constructed message, which is specifically represented in the following form:

xpc_send_message(conn, dic).

In that, the sending unit 230 is mainly adapted to upload the constructed message to the interface for message sending by the background program via the connection channel for message sending by the background program, and send, by the background program, the message via the interface for message sending by the background program.

In that, the result receiving unit 240 is mainly adapted to receive a result indicating whether the message is successfully sent, and if the sending fails, notify the sending unit 230 to perform resending by the background program.

In the present embodiment, when the background program sends the message, it receives a result indicating whether the message is successfully sent, that is to say, after the background program sends the message to a preset address, the result receiving unit 240 receives a message indicating whether the message is successfully sent. If the message is not successfully sent, it notifies the sending unit 230 to resend, and the sending unit 230 may set limitation to times of resending the message by the background program. For example, a message sent by each background program is resent three times at most.

The device of the present embodiment realizes automatic message sending by the background program without the need for inputting a phone number or message content by a user, and the sending process does not affect the normal operation of the system. Meanwhile, since the background program receives a message indicating whether the message is successfully sent during the sending process, the result of message sending may be obtained. Resending is attempted in the event of sending failure, thereby improving the success rate of message sending by the background program so that the process of the message sending by the background program is controllable.

To conclude, the present embodiment realizes automatic message sending by a background program without the need for inputting a phone number or message content by a user, and the sending process does not affect the normal operation of the system, thereby achieving a function that cannot be achieved by foreground message sending.

Meanwhile, since the background program receives a message indicating whether the message is successfully sent during the sending process, the message sending result may be obtained. Resending is attempted in the event of sending failure, thereby improving the success rate of message sending by the background program so that the process of the message sending by the background program is controllable.

It should be noted that:

The algorithm and display provided herein are not intrinsically related to any specific computer, virtual system or other devices. Various general devices may also be used together with the teaching based on this. According to the above depictions, the structures required for constructing such type of devices are apparent. Further, the present invention is not with respect to any specific programming language. It shall be understood that various programming languages may be used to implement the content of the present invention described herein, and the above depictions for a specific language are intended to reveal the preferred embodiments of the present invention.

The description as provided herein describes a lot of specific details. However, it is appreciated that the embodiments of the present invention may be implemented in the absence of these specific details. Some embodiments do not specify in detail known methods, structures and techniques to not obscure the understanding of the description.

Similarly, it should be appreciated that in order to simplify the present invention and help understand one or more aspects of the present invention, in the above depictions of the exemplary embodiments of the present invention, the features of the present invention are sometimes grouped together to an individual embodiment, figure or depiction thereof. However, the disclosed method should not be interpreted as the following intention: the claimed present invention claims more features than the features explicitly recited in each claim. More exactly, as reflected by the following claims, the aspects of the disclosure are less than all the features of the individual embodiments disclosed above. Therefore, the claims conforming to the specific embodiments are thereby explicitly incorporated into the specific embodiments, wherein each claim itself serves as an individual embodiment of the present invention.

Those skilled in the art may appreciate that the modules in the apparatus in the embodiments may be changed adaptively and be set in one or more apparatuses different from the present embodiment. The modules or units or assemblies in the embodiment may be combined into one module or unit or assembly, and moreover, they may be divided into a plurality of submodules, subunits or subassemblies. Except that at least some of such features or processes or units are mutually contradictory, all the features disclosed in the specification (including the accompanying claims, abstract and figures) and all the processes or units of any method or apparatus disclosed in this way may be combined by employing any combination. Unless otherwise stated expressly, each feature disclosed in the specification (including the accompanying claims, abstract and figures) may be replaced with an alternative feature providing identical, equivalent or similar objective.

In addition, those skilled in the art can understand that although some embodiments described herein include some features rather than other features included in other embodiments, the combination of the features of different embodiments means being within the scope of the present invention and forming different embodiments. For example, in the appended claims, any one of the claimed embodiments may be used in an arbitrary combination.

The embodiments regarding the parts in the present invention may be implemented in hardware, or implemented by software modules running on one or more processors, or implemented in their combinations. Those skilled in the art should appreciate that a microprocessor or digital signal processor (DSP) may be used in practice to implement some or all functions of some or all parts of the device for message sending by a background program according to the embodiments of the present invention. The present invention may also be implemented as an apparatus or device program (e.g., computer program and computer program product) for executing part or all of the method described herein. Such programs implementing the present invention may be stored in a computer-readable medium, or may be in the form of one or more signals. Such signals can be obtained by downloading from the Internet, or provided on a carrier signal or provided in any other forms.

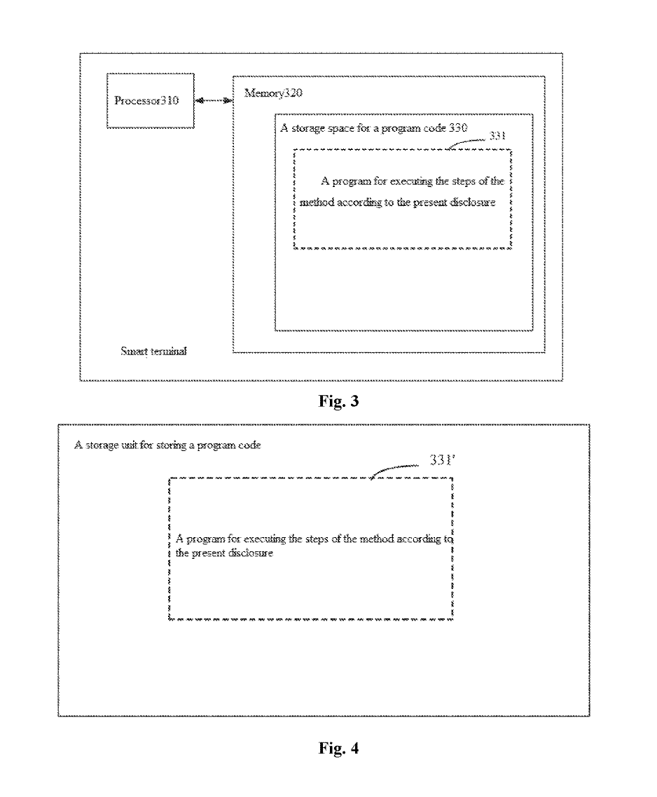

For example, FIG. 3 illustrates a terminal that may implement the method for message sending by the background program according to the present invention, for example a smart terminal. The terminal conventionally comprises a processor 310 and a computer program product or computer-readable medium in form of a memory 320. The memory 320 may be an electronic memory such as flash memory, EEPROM (Electrically Erasable Programmable Read-Only Memory), EPROM, hard disk or ROM. The memory 320 has a storage space 330 for a program code 331 executing any step of the above method. For example, the storage space 330 for the program code may comprise program codes 331 for individually implementing the steps of the above method. These program codes may be read from one or more computer program products or written into the one or more computer program products. These computer program products comprise program code carriers such as hard disk, compact disk (CD), memory card or floppy disk. Such computer program products are usually portable or fixed storage units as shown in FIG. 4. The storage unit may have a storage section, a storage space or the like arranged in a similar way to the memory 320 in the terminal of FIG. 3. The program code may for example be compressed in a suitable form. Usually, the storage unit comprises a computer readable code 331″, namely, a code readable by a processor such as 310. When these codes are run by the terminal, the terminal is caused to execute the steps of the method described above.

It should be noted that the above-described embodiments are intended to illustrate but not to limit the present invention, and alternative embodiments may be devised by the person skilled in the art without departing from the scope of claims as appended. In the claims, any reference symbols between brackets form no limit of the claims. The wording “include” does not exclude the presence of elements or steps not listed in a claim. The wording “a” or “an” in front of an element does not exclude the presence of a plurality of such elements. The disclosure may be realized by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings may be interpreted as a name.

1. A method for sending a message by a background program, comprising:
acquiring a connection channel for messages ending by the background program;
constructing the message to be sent, according to a scenario of message sending by the background program;
acquiring an interface for message sending by the background program; and
uploading the constructed message to the interface via the connection channel, and sending, by the background program, the constructed message via the interface.

2. (canceled)

3. The method according to claim 1, wherein the constructed message comprises the following information:
a message type, a message recipient, message content and a unique identifier of the message.

4. The method according to claim 3, wherein the constructed message further comprises at least one of the following information:
(a) a message subject and (b) whether to push sending the message.

5. The method according to claim 3, wherein the message recipient is an array that stores at least one message recipient phone number or E-mail address.

6. The method according to claim 5, wherein the at least one message recipient phone number or E-mail address comprises:
at least one message recipient phone number or E-mail address preset by a user, or at least one message recipient phone number that is selected from mobile phone contacts and that has a maximum number of calls, or at least one message recipient phone number that is selected from mobile phone contacts and whose call duration is the longest, or at least one message recipient phone number or E-mail address selected randomly from all contacts.

7. (canceled)

8. The method according to claim 1, wherein the constructing the message to be sent, further comprises:
determining a recipient of the message according to the scenario of message sending by the background program.

9. The method according to claim 8, wherein the determining the recipient of the message according to the scenario of message sending by the background program comprises:
the background program sends a message to a designated recipient in the scenario in which a SIM card has changed for the mobile phone, and the recipient of the message sending by the background program is one or more selected from anti-theft contacts preset by the user; or one or more contacts who are selected from the mobile phone contacts and who have a maximum number of calls; or one or more contacts who are selected from the mobile phone contacts and whose call duration is the longest; or one or more contacts selected randomly from all mobile phone contacts; or
in the scenario in which the background program executes a user operation instruction after the mobile phone is stolen and then replies with a message, the recipient of the message sending by the background program is a phone number or E-mail address that sends the operation instruction; or
in the scenario in which the background program automatically subscribes to services, the recipient of the message sending by the background program is a mobile phone or E-mail address for subscribing services that is set by the user; or
in the scenario in which the background program automatically replies with a message after a phone call is rejected, the recipient of the message sending by the background program is a rejected phone number.

10. (canceled)

11. The method according to claim 1, wherein the method further comprises:
receiving a result message indicating whether the message is successfully sent, and if the sending fails, to resend the message.

12. (canceled)

13. (canceled)

14. The method according to claim 1, wherein
the message sending by the background program refers to directly sending the message without invoking a message interface.

15. (canceled)

16. A device for sending message by a background program, comprising a memory having instructions stored therein and at least one processor to execute the instructions to perform operations for sending a message by a background program, the operations comprising:
acquiring a connection channel for message sending by the background program;
constructing the message to be sent, according to a scenario of message sending by the background program;
acquiring an interface for message sending by the background program; and
uploading the constructed message to the interface via the connection channel, and sending, by the background program, the constructed message via the interface.

17. (canceled)

18. The device according to claim 16, wherein the constructed message comprises the following information:
a message type, a message recipient, message content and a unique identifier of the message.

19. The device according to claim 18, wherein the constructed message further comprises at least one of the following information:
(a) a message subject; and (b) whether to push sending the message.

20. The device according to claim 18, wherein the message recipient is an array that stores at least one message recipient phone number or E-mail address.

21. The device according to claim 20, wherein the at least one message recipient phone number or E-mail address comprises:
at least one message recipient phone number or E-mail address preset by the user, or at least one message recipient phone number or E-mail address that is selected from mobile phone contacts and that has a maximum number of calls, or at least one message recipient phone number or E-mail address that is selected from mobile phone contacts and whose call duration is the longest, or at least one message recipient phone number or E-mail address selected randomly from all contacts.

22. (canceled)

23. The device according to claim 16, wherein the constructing the message to be sent, further comprises:
determining a recipient of the message according to the scenario of message sending by the background program, comprising any one of the following:
the background program sends a message to a designated recipient in the scenario in which a SIM card has changed for the mobile phone, and the recipient of the message sending by the background program is one or more selected from anti-theft contacts preset by the user; or one or more contacts who are selected from the mobile phone contacts and who have a maximum number of calls; or one or more contacts who are selected from the mobile phone contacts and whose call duration is the longest; or one or more contacts selected randomly from all mobile phone contacts; or
in the scenario in which the background program executes a user operation instruction after the mobile phone is stolen and then replies with a message, the recipient of the message sending by the background program is a phone number or E-mail address that sends the operation instruction; or
in the scenario in which the background program automatically subscribes to services, the recipient of the message sending by the background program is a mobile phone or E-mail address for subscribing services that is set by the user; or
in the scenario in which the background program automatically replies with a message after a phone call is rejected, the recipient of the message sending by the background program is a rejected phone number.

24. (canceled)

25. The device according to claim 16, wherein the operations further comprise:
receiving a result indicating whether the message is successfully sent, and if the sending fails, resend the message.

26. (canceled)

27. (canceled)

28. The device according to claim 16, wherein
the message sending by the background program refers to directly sending the message without invoking a message interface.

29. (canceled)

30. (canceled)

31. A computer-readable medium, having instructions stored therein that, when executed by at least one processor, cause the at least one processor to perform operations for sending a message by a background program, the operations comprising:
acquiring a connection channel for message sending by the background program:
constructing the message to be sent, according to a scenario of message sending by the background program;
acquiring an interface for message sending by the background program; and
uploading the constructed message to the interface via the connection channel, and sending, by the background program, the constructed message via the interface.

32. The computer-readable medium according to claim 31, wherein the operations further comprises:
receiving a result indicating whether the message is successfully sent, and if the sending fails, resend the message.

33. The computer-readable medium according to claim 31, wherein the message sending by the background program refers to directly sending the message without invoking a message interface.
